(19) United States
(12) Patent Application Publication
(10) Pub. No.: US 2008/0185471 A1
(43) Pub. Date: Aug. 7, 2008

(54) Aligning tape winding in tape cartridge

(76) Inventors: Stephen V. Deckers, Eagle, ID (US); Robert C. Aaron, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/702,720

(22) Filed: Feb. 6, 2007

(51) Int. Cl. G11B 23/087

(52) U.S. Cl. 242/345

(57) ABSTRACT

In a tape cartridge, a flexible spacer flexibly biases each winding of the spool of tape into alignment with a previous winding of the tape on a flangeless spool.

### BACKGROUND

Tape cartridges or cassettes, such as DAT (digital audio tape), DSS (digital data storage by Sony Corporation), etc., have a hub around which the tape is wound as a spool of tape. Some other types of tape cartridges have flanges on the hub to guide each winding of the tape into alignment with a previous winding of the tape in the spool. The DAT and DSS cartridges, among others, however, have a flangeless hub. Not having flanges allows more tape to be wound into the spool because the space available for one fully packed spool overlaps the space available for the other. Thus, the cartridge can hold more information or data.

Without flanges, however, it is more difficult to guide each winding of the tape onto the previous winding as the tape is being wound by a tape drive mechanism, particularly if the drive mechanism doesn't control the positioning of the tape very well. In this case, there can possibly be too much movement of the tape, so the tape packs too high or too low in the spool.

It is important to align the windings of the tape to prevent the tape from slipping off the spool or being damaged by undue stretching or bending within the drive mechanism or the cassette. Otherwise, the cartridge can be rendered inoperable and/or the data contained therein lost. Additionally, if the tape is not properly aligned when being passed through the drive mechanism, then errors may occur in the writing or reading of the data, thereby reducing the efficiency or performance characteristics of the tape and the drive mechanism.

Such flangeless cartridges typically have guide sheets between the inner surfaces of the cassette housing and the spool of tape. These guide sheets assist in aligning the tape on the spool of tape as the tape is being wound. Sometimes rigid plastic ribs are formed in the inner surface of the cartridge housing to support the guide sheets close to the spool of tape.

The guide sheets are sometimes called friction sheets, because the guide sheets cause less friction against the tape edge than do the inner surfaces of the housing. The tape edge rubs against the guide sheets as the tape moves, thereby causing a friction force between the tape and guide sheets that retards movement of the tape. Motors within the tape drive mechanism must overcome the friction of the tape against the guide sheets in order to turn the spool of tape. If the motor has to pull harder on the tape, then tension on the tape will increase, possibly resulting in tape edge damage as the tape is pulled through the tape drive mechanism. Further increases in tape tension may exceed the ability of the motors to pull the tape.

There is a tradeoff between the tape alignment capability of the guide sheets and the amount of friction generated between the moving tape and the guide sheets. If the guide sheets are held closely to the tape by the inner surfaces, or rigid plastic ribs, of the housing, then the alignment of the tape will be desirably good, but the tape will be tightly constrained, thus the friction forces will be undesirably high. On the other hand, if the guide sheets are given a lot of room between the tape and the inner surfaces of the housing, then the tape will be less constrained, thus the friction forces will be desirably low, but the alignment of the tape will be undesirably poor.

### BRIEF DESCRIPTION OF THE DRAWINGS

FIG. 1 is a perspective view of an exemplary tape cassette incorporating an embodiment of the present invention.

FIG. 2 is an exploded perspective view of the exemplary tape cassette (without a tape) shown in FIG. 1 incorporating an embodiment of the present invention.

FIG. 3 is an exploded perspective view of portions of the exemplary tape cassette shown in FIG. 1 incorporating an embodiment of the present invention.

FIG. 4 is a cross section view taken along section line 4-4 in FIG. 1 (with a portion enlarged) of the exemplary tape cassette shown in FIG. 1 incorporating an embodiment of the present invention.

FIG. 5 is a simplified plan view of a portion of an exemplary tape cassette housing incorporating an alternative embodiment of the present invention.

FIG. 6 is a simplified plan view of a portion of an exemplary tape cassette housing incorporating another alternative embodiment of the present invention.

FIG. 7 is an alternative embodiment for the enlarged portion of the cross section shown in FIG. 6.

FIG. 8 is an end view of a flexible spacer for use in the exemplary tape cassette shown in FIG. 1 incorporating an alternative embodiment of the present invention.

FIG. 9 is a side view of a guide sheet for use in the exemplary tape cassette shown in FIG. 1 incorporating an alternative embodiment of the present invention.

FIG. 10 is a side view of a guide sheet for use in the exemplary tape cassette shown in FIG. 1 incorporating another alternative embodiment of the present invention.

FIG. 11 is a side view of a guide sheet for use in the exemplary tape cassette shown in FIG. 1 incorporating yet another alternative embodiment of the present invention.

### DETAILED DESCRIPTION

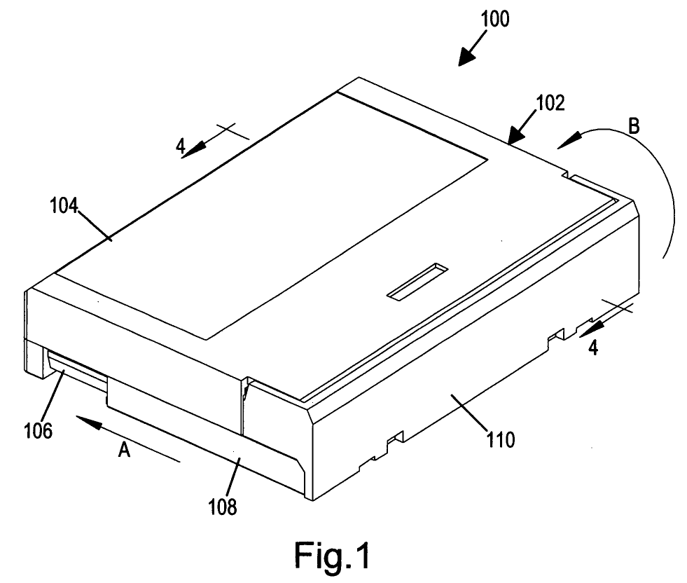

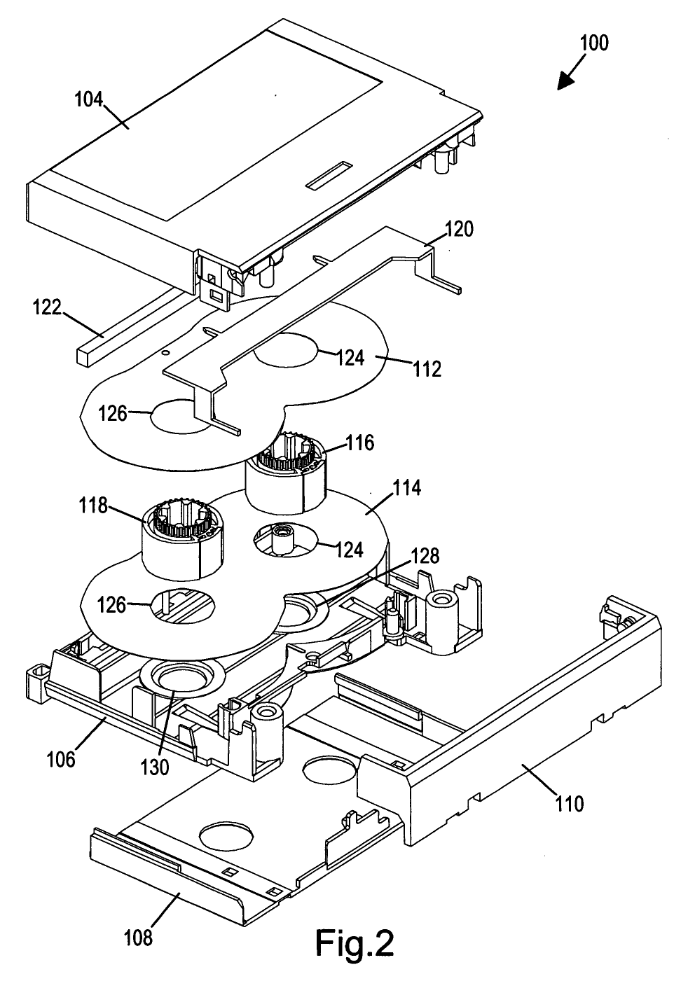

An exemplary tape cassette, or cartridge, 100 is shown in FIGS. 1 and 2 incorporating an embodiment of the present invention (as described below). The tape cartridge 100 generally includes a cartridge housing 102 (top housing portion 104, primary bottom housing portion 106 and retractable bottom housing portion 108), a door panel 110, top and bottom guide sheets 112 and 114, flangeless hubs 116 and 118, a hub-locking mechanism 120 and at least one flexible spacer 122, among other components. A recording tape wraps around the flangeless hubs 116 and 118 to form flangeless spools of the tape. (The tape is not shown in FIG. 2 in order to more clearly show other parts of the tape cartridge 100.) The tape cartridge 100 enables proper alignment of windings of the tape on the flangeless hubs 116 and 118 during packing of the tape without causing undue friction that retards the action of winding the spools of tape.

The bottom housing portions 106 and 108 attach together in such a manner that the retractable bottom housing portion 108 can slide relative to the primary bottom housing portion 106 from the position shown in FIG. 1 to a retracted position in the direction of arrow A. A spring normally biases the retractable bottom housing portion 108 in the position shown in FIG. 1. The top housing portion 104 and the door panel 110 attach together in such a manner that the door panel 110 can pivot relative to the top housing portion 104 from a closed position shown in FIG. 1 to an open position in the direction of arrow B. A spring normally biases the door panel 110 in the closed position shown in FIG. 1.

The guide sheets 112 and 114 are generally shaped to be able to cover the spool of tape, when the tape is wound around either of the flangeless hubs 116 and 118. Also, the guide sheets 112 and 114 have holes 124 and 126 corresponding to the placement of the flangeless hubs 116 and 118, respectively. The bottom guide sheet 114 sits on the primary bottom housing portion 106. A portion of the flangeless hubs 116 and 118 protrudes through the holes 124 and 126, respectively, of the bottom guide sheet 114, so the flangeless hubs 116 and 118 can be seated in circular retainers 128 and 130, respectively, in the primary bottom housing portion 106.

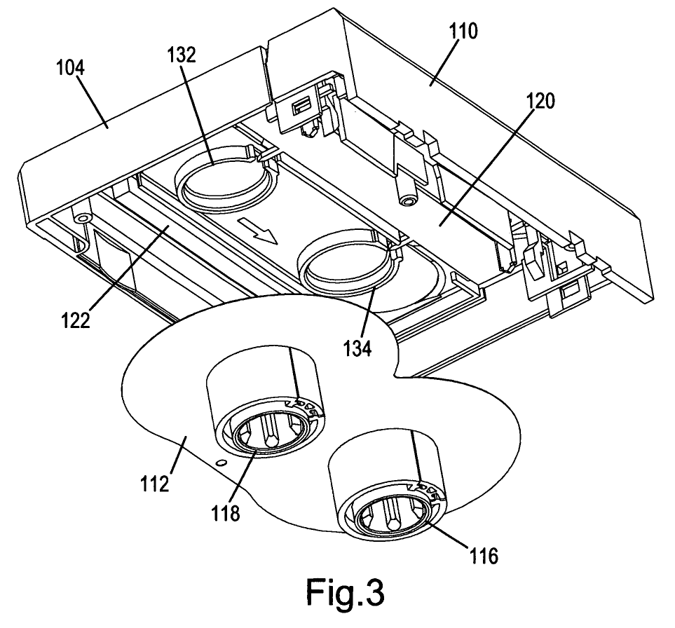

The top guide sheet 112 sits on the spool of tape. Another portion of the flangeless hubs 116 and 118 protrudes through the holes 124 and 126, respectively, of the top guide sheet 112, so the flangeless hubs 116 and 118 can also be seated in circular retainers 132 and 134 (FIG. 3), respectively, in the top housing portion 104 when the top housing portion 104 is attached to the primary bottom housing portion 106.

The hub-locking mechanism 120 attaches to the top housing portion 104 and the door panel 110. When the door panel 110 is in the closed position, the hub-locking mechanism 120 is held in a position at which it engages the flangeless hubs 116 and 118 to prevent the flangeless hubs 116 and 118 from rotating. When the door panel 110 is pivoted to the open position, the hub-locking mechanism 120 is moved to a position at which it does not engage the flangeless hubs 116 and 118, so the flangeless hubs 116 and 118 are free to rotate.

The tape is attached between the two flangeless hubs 116 and 118. When the tape cartridge 100 is inserted into a tape drive mechanism, the door panel 110 is pivoted up (arrow B) and the retractable bottom housing portion 108 is retracted (arrow A) to expose the tape and provide bottom access to the flangeless hubs. Also, the hub-locking mechanism 120 releases the flangeless hubs 116 and 118. The tape drive mechanism can then move the tape back and forth between the flangeless hubs 116 and 118 reeling the tape into the spool on one of the flangeless hubs 116 or 118 and off of the spool on the other flangeless hub 116 or 118.

The tape cartridge 100 is illustrated as a type referred to as DAT (digital audio tape) or DSS (digital data storage by Sony Corporation). However, the invention is not limited to such tape cartridges, but may be incorporated in any appropriate tape cartridge having flangeless spools of tape.

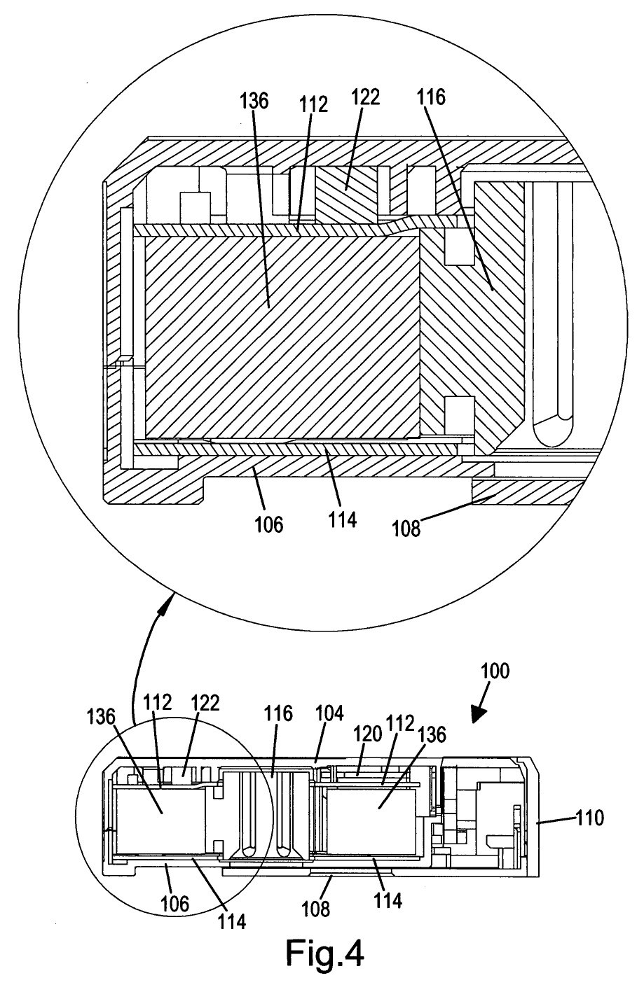

The flexible spacer 122, in the embodiment shown in FIGS. 3 and 4, is an elongated strip of any appropriate flexible material, such as foam, rubber, sponge, etc. The flexible spacer 122 is attached to the inner surface of the top housing portion 104. Thus, the flexible spacer 122 is disposed between the inner surface of the top housing portion 104 and the top guide sheet 112.

The flexible spacer 122 gently pushes against the top guide sheet 112 to flexibly bias the top guide sheet 112, the spools of tape 136 on the flangeless hubs 116 and 118 and the bottom guide sheet 114 toward the inner surface of the primary bottom housing portion 106. In this manner, the flexible spacer 122 gently forces each winding of the tape 136 into alignment with the previous winding, so proper packing of the spools of tape 136 is enhanced. Additionally, the relative flexibility of the flexible spacer 122 results in only a slight compression force, or soft compliant contact, on the spools of tape 136, instead of a large compression force that has been found to result from a relatively rigid spacer, or rib, pressing against the spools of tape 136. Thus, there is a partial, but insignificant, retarding of the winding action. Therefore, the flexible spacer 122 causes the tape windings to be aligned without causing too much friction force retarding the action of winding the spools of tape 136 around both flangeless hubs 116 and 118.

The proper alignment of the spools of tape 136 also reduces lateral tape motion as the tape exits the tape cartridge 100 into the tape drive mechanism. As a result, the tape drive mechanism can write and read data to and from the tape with better precision. Thus, there is a significant improvement in overall function, efficiency or performance of the tape and the drive mechanism due to a reduced number of re-writes or re-reads when writing data to the tape or reading data from the tape.

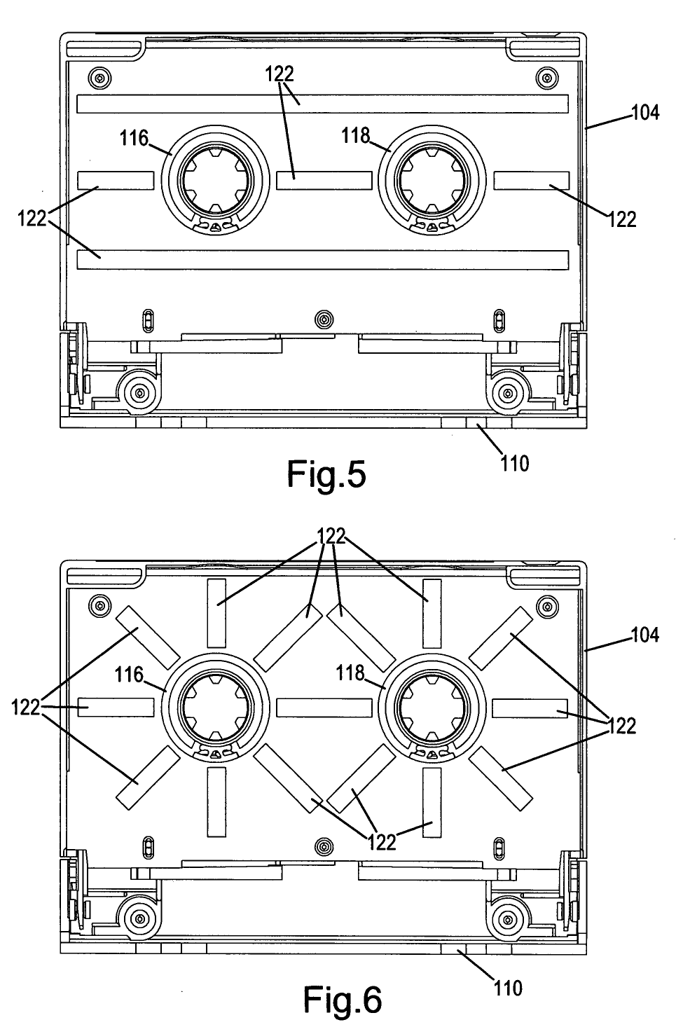

Alternative embodiments for the number and placement of the flexible spacers 122 are shown in FIGS. 5 and 6. FIG. 5 shows an embodiment in which more than one of the flexible spacers 122 is arranged in parallel strips surrounding the circular retainers 128 and 130 and the flangeless hubs 116 and 118. FIG. 6, on the other hand, shows an embodiment in which more than one of the flexible spacers 122 is arranged in radial patterns surrounding the circular retainers 128 and 130 and the flangeless hubs 116 and 118. Additional embodiments may incorporate any appropriate placement, number, combination and/or shape of the flexible spacers 122.

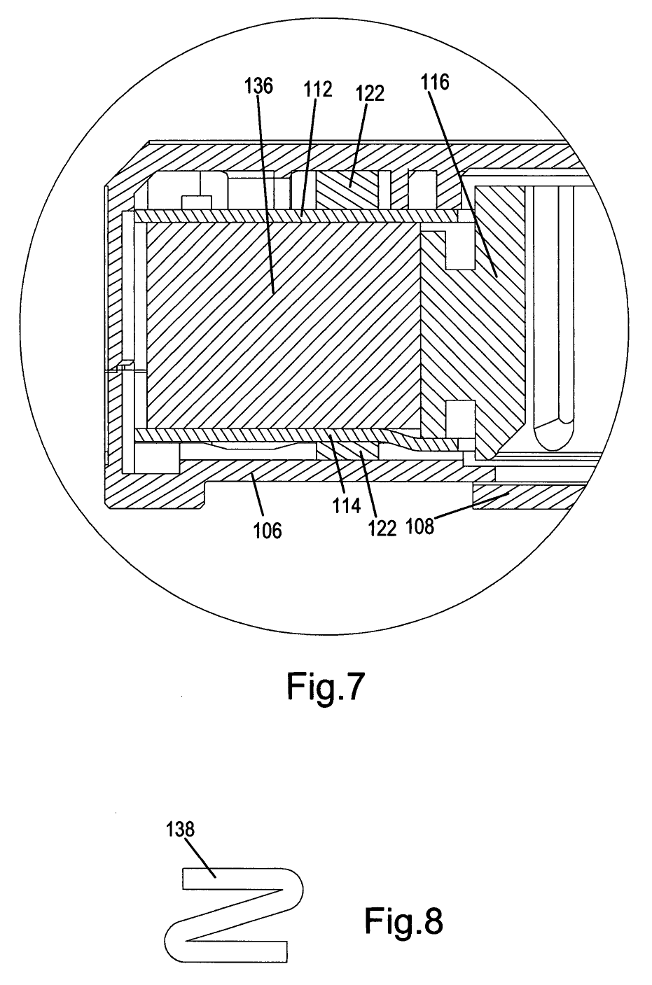

FIG. 7 shows an alternative embodiment in which the flexible spacers 122 are placed on the inner surface of both the top housing portion 104 and the primary bottom housing portion 106. The spool of tape 136 and the guide sheets 112 and 114 are, thus, slightly compressed between the flexible spacers 122. Additional embodiments may have the flexible spacers 122 on both housing portions 104 and 106 and arranged similarly to any of the patterns or combinations of patterns shown in the embodiments of FIGS. 3, 5 and 6.

FIG. 8 shows a flexible spacer 138 according to an alternative embodiment. The flexible spacer 138 is an accordion-folded elongated strip of material. The flexible spacer 138 is a spring made of plastic, spring steel or any other suitable material that can be folded or molded into the general shape shown, but with any number of folds, to form an accordion spring. The flexible spacer 138 can be used in place of any of the flexible spacers 122 in any of the embodiments described above.

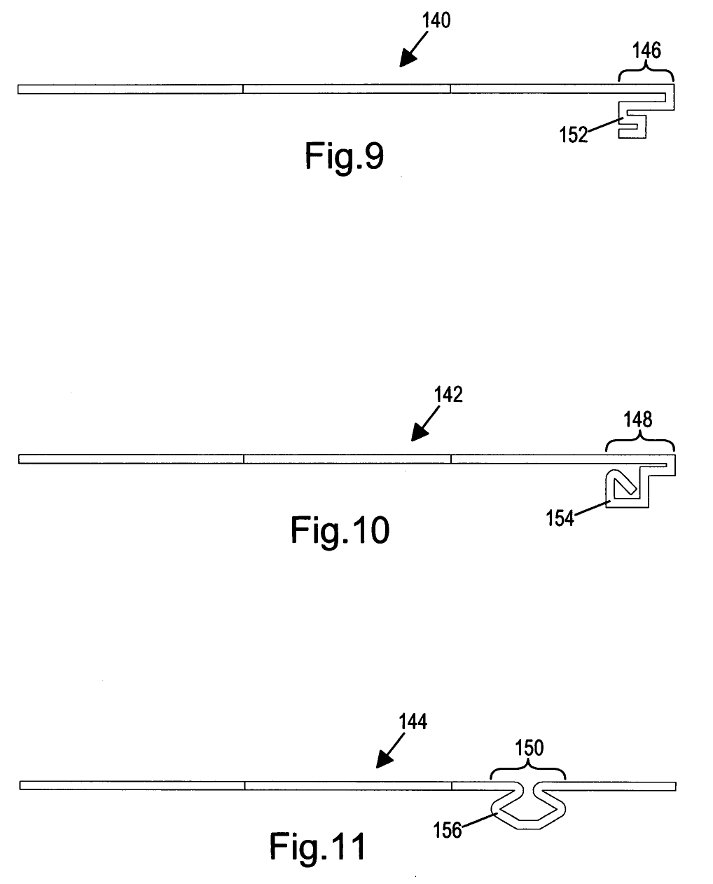

FIGS. 9, 10 and 11 show exemplary guide sheets 140, 142 and 144, respectively, according to alternative embodiments. The guide sheets 140, 142 and 144 have a series of folds at 146, 148 and 150, respectively. The folds at 146, 148 and 150 form various accordion-folded spring portions 152, 154 and 156, respectively, on one side of the guide sheets 140, 142 and 144, respectively. (Alternatively, more than one such spring portions 152, 154 and 156 may be formed in the guide sheets 140, 142 and 144 at various appropriate locations, in any combinations and with any number of folds.) The guide sheets 140, 142 and 144 can be used in place of one (or both) of the guide sheets 112 and 114 and the flexible spacer(s) 122, above. In this case, the guide sheets 140, 142 and 144 are preferably placed in the tape cartridge 100 with the spring portions 152, 154 and 156 of the guide sheets 140, 142 and 144 toward the inner surface of either the top housing portion 104 or the primary bottom housing portion 106. The spring portions 152, 154 and 156 thus flexibly bias the guide sheets 140, 142 and 144 against the spool of tape 136 to ensure alignment of the windings during packing of the tape without causing undue compression or friction forces that retard the action of winding the spool of tape 136.

We claim:

1. A tape cartridge comprising:
a flangeless spool of tape;
a cartridge shell; and
a flexible spacer between the spool of tape and a portion of the cartridge shell, the flexible spacer flexibly biasing each winding of the spool of tape into alignment with a previous winding as the tape winds onto the spool.

2. A tape cartridge as defined in claim 1, wherein the aforementioned flexible spacer is a first flexible spacer and the aforementioned portion of the cartridge shell is a first portion of the cartridge shell, further comprising:
a second flexible spacer between the spool of tape and a second portion of the cartridge shell, the second flexible spacer being on a opposite side of the spool of tape from the first flexible spacer, and the first and second flexible spacers flexibly biasing each winding of the spool of tape into alignment with a previous winding as the tape winds onto the spool.

3. A tape cartridge as defined in claim 1, wherein:
the flexible spacer maintains a flexible force on the spool of tape resulting in a frictional force that retards winding of the tape, while allowing a motor for driving the winding of the tape to turn the spool of tape.

4. A tape cartridge as defined in claim 1, wherein:
the flexible spacer is foam.

5. A tape cartridge as defined in claim 1, wherein:
the flexible spacer is a spring.

6. A tape cartridge as defined in claim 1, wherein:
the flexible spacer is a single elongated strip.

7. A tape cartridge as defined in claim 1, further comprising:
a plurality of flexible spacers between the spool of tape and portions of the cartridge shell, the flexible spacers flexibly biasing each winding of the spool of tape into alignment with the previous winding as the tape winds onto the spool.

8. A tape cartridge as defined in claim 1, further comprising:
a guide sheet disposed between the spool of tape and the cartridge shell;
and wherein:
the flexible spacer is a folded portion of the guide sheet.

9. A tape cartridge comprising:
a flangeless means for receiving a tape, the tape being wound around the flangeless receiving means;
a means for housing the tape; and
a means, between the housing means and the tape, for flexibly biasing each winding of the tape into alignment with a preceding winding of the tape as the tape is wound onto the flangeless receiving means, the flexibly biasing means maintaining a flexible force on the wound tape resulting in a frictional force that partially retards winding of the tape, but allows a means for driving the winding of the tape to turn the flangeless receiving means.

10. A tape cartridge as defined in claim 9, wherein the aforementioned flexibly biasing means is a first flexibly biasing means, further comprising:
a second means, between the housing means and the tape on a opposite side of the tape from the first flexibly biasing means, for flexibly biasing, in cooperation with the first flexibly biasing means, each winding of the tape into alignment with a preceding winding of the tape as the tape is wound onto the flangeless receiving means, the first and second flexibly biasing means maintaining a flexible force on the wound tape resulting in a frictional force that retards winding of the tape, while allowing a means for driving the winding of the tape to turn the flangeless receiving means.

11. A tape cartridge as defined in claim 9, wherein:
the flexibly biasing means is foam.

12. A tape cartridge as defined in claim 9, wherein:
the flexibly biasing means is a spring.

13. A tape cartridge as defined in claim 9, wherein:
the flexibly biasing means is a single elongated strip.

14. A tape cartridge as defined in claim 9, further comprising:
a plurality of means, between the housing means and the tape, for flexibly biasing each winding of the tape into alignment with the preceding winding of the tape as the tape is wound onto the flangeless receiving means.

15. A tape cartridge as defined in claim 9, further comprising:
a guide sheet disposed between the tape and the housing means; and wherein:
the flexibly biasing means is a folded portion of the guide sheet.

16. A method for packing a tape in a tape cartridge, comprising:
reeling the tape onto a flangeless tape spool within the tape cartridge; and
flexibly biasing, by a flexible spacer within the tape cartridge, each winding of the tape into alignment with a previous winding of the tape.

17. A method as defined in claim 16, wherein the aforementioned flexible spacer is a first flexible spacer, further comprising:
flexibly biasing, by a second flexible spacer within the tape cartridge on an opposite side of the tape from the first flexible spacer, each winding of the tape into alignment with a previous winding of the tape.

18. A method as defined in claim 16, further comprising:
the flexible spacer maintaining a flexible force on the flangeless tape spool resulting in a frictional force that retards winding of the tape, while allowing a motor for driving the winding of the tape to turn the flangeless tape spool.

19. A method as defined in claim 16, wherein:
the flexible spacer is foam.

20. A method as defined in claim 16, wherein:
the flexible spacer is a spring.

21. A method as defined in claim 16, wherein:
the flexible spacer is a single elongated strip.

22. A method as defined in claim 16, further comprising:
flexibly biasing, by a plurality of flexible spacers within the tape cartridge, each winding of the tape into alignment with the previous winding of the tape.

23. A method as defined in claim 16, wherein:
the tape cartridge further comprises a guide sheet disposed between the spool of tape and the cartridge shell; and;
the flexible spacer is a folded portion of the guide sheet.
